(19) United States
(12) Patent Application Publication
(10) Pub. No.: US 2025/0299425 A1
(43) Pub. Date: Sep. 25, 2025

(54) IMAGE PROCESSING METHOD, ELECTRONIC DEVICE AND STORAGE MEDIUM

(71) Applicant: Beijing Zitiao Network Technology Co., Ltd., Beijing (CN)

(72) Inventors: Huaiye SHEN, Beijing (CN); Yunhao LIAO, Beijing (CN)

(21) Appl. No.: 18/861,544

(22) PCT Filed: Apr. 25, 2023
(86) PCT No.: PCT/CN2023/090555

§ 371 Date: Oct. 29, 2024

(30) Foreign Application Priority Data
Apr. 29, 2022 (CN) 202210476189.6

(51) Int. Cl. G06T 15/10; G06T 3/4038; G06T 3/60; G06T 7/13; G06T 15/04

(52) U.S. Cl. CPC G06T 15/10; G06T 3/4038; G06T 3/60; G06T 7/13; G06T 15/04; G06T 2207/20132; G06T 2210/12; G06T 2210/22

(57) ABSTRACT

An image processing method and apparatus, an electronic device, and a storage medium are provided, the image processing method includes: processing an image to be processed to obtain a panoramic complementary image of a target pixel ratio according to an image attribute of the image to be processed; determining a plurality of target patch maps on a bounding box according to the panoramic complementary image; wherein a displayed content on the bounding box corresponds to the panoramic complementary image; and determining a panoramic surround image based on the plurality of target patch maps.

The present application claims the priority of a Chinese patent application filed to the China National Intellectual Property Administration on Apr. 29, 2022, with application number 202210476189.6, and its entire content is incorporated in this application by reference.

### TECHNICAL FIELD

Embodiments of the present disclosure relate to the field of image processing technology, for example, to an image processing method, apparatus, electronic device, and storage medium.

### BACKGROUND

With the development of network technology, more and more application programs, such as a series of software that can shoot short videos, have entered the lives of users, and are deeply loved by users.

In related technologies, related application software can provide users with various image processing functions, so that an image can present other visual effects after processing. However, when users want to obtain a panoramic surround image corresponding to one image, they usually need to actively upload the original image to the server, and then the relevant application software will perform multiple processing on the image. However, this method is relatively cumbersome and the efficiency of image processing is low. At the same time, when the application is deployed on a mobile terminal, real-time processing of the image cannot be achieved, thereby reducing the user experience.

### SUMMARY

The present disclosure provides an image processing method, apparatus, electronic device, and storage medium, which can not only generate a panoramic surround image corresponding to the image to be processed based on a mobile terminal, but also improve image processing efficiency in a concise way, and improve the user experience while meeting the personalized needs of users.

In the first aspect, the embodiments of the present disclosure provide an image processing method, which includes:
processing an image to be processed to obtain a panoramic complementary image of a target pixel ratio according to an image attribute of the image to be processed;
determining a plurality of target patch maps on a bounding box according to the panoramic complementary image; in which a displayed content on the bounding box corresponds to the panoramic complementary image; and
determining a panoramic surround image based on the plurality of target patch maps.

In the second aspect, the embodiments of the present disclosure further provide an image processing method, which includes:
a panoramic complementary image determination module, configured to process an image to be processed to obtain a panoramic complementary image of a target pixel ratio according to an image attribute of the image to be processed;
a target patch map determination module, configured to determine a plurality of target patch maps on a bounding box according to the panoramic complementary image; in which a displayed content on the bounding box corresponds to the panoramic complementary image; and
a panoramic surround image determination module, configured to determine a panoramic surround image based on the plurality of target patch maps.

In the third aspect, the embodiments of the present disclosure further provide an electronic device, which includes:
at least one processor; and
a storage apparatus, configured to store at least one program,
the at least one program causes the at least one processor to implement the image processing method provided by any embodiment of the present disclosure when executed by the at least one processor.

In the fourth aspect, the embodiments of the present disclosure further provide a readable storage medium including a computer program, the computer program is configured to execute the image processing method provided by any embodiment of the present disclosure when executed by a computer processor.

### BRIEF DESCRIPTION OF DRAWINGS

FIG. 1 is a flowchart of an image processing method provided by the embodiments of the present disclosure;

FIG. 2 is a structural diagram of an image processing apparatus provided by the embodiments of the present disclosure; and

FIG. 3 is a structural diagram of an electronic device provided by the embodiments of the present disclosure.

### DETAILED DESCRIPTION

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units. Modifications of “one” and “more” mentioned in the present disclosure are schematic rather than restrictive, and those skilled in the art should understand that unless otherwise explicitly stated in the context, it should be understood as “at least one”.

The names of the messages or information exchanged between multiple devices in the embodiments of the present disclosure are for illustrative purposes only and are not intended to limit the scope of these messages or information.

Before introducing the technical solution, exemplary explanations can be provided for the application scenarios of the embodiments of the present disclosure.

For example, when users use the image processing functions provided by the application software, they may also have personalized needs. For example, users want to use the application software to generate a panoramic surround image corresponding to one image. In this need, the image can be mapped onto a sphere, and the corresponding panoramic surround image can be obtained by mapping the surface content of the sphere. However, in the field of computer vision, the sphere requires a large number of vertices and faces to describe. At the same time, there is significant information redundancy at the two poles of the sphere, which leads to significant computation overhead in the image processing process and is not conducive to image processing by mobile terminals with limited performance; or, specific image processing software can be used to process the image first, and then a panoramic surround image corresponding to the image can be constructed based on the processing results. This image processing method is too cumbersome and inefficient.

At this point, according to the technical solution of this embodiment, the panoramic complementary image corresponding to the image to be processed can be determined first. Then, according to the panoramic complementary image, a plurality of target patch maps on the rectangular bounding box can be determined. For example, based on the plurality of target patch maps, the panoramic surround image is determined, which not only allows for generating a panoramic surround image corresponding to the image to be processed on the mobile terminal, but also improves image processing efficiency in a concise way.

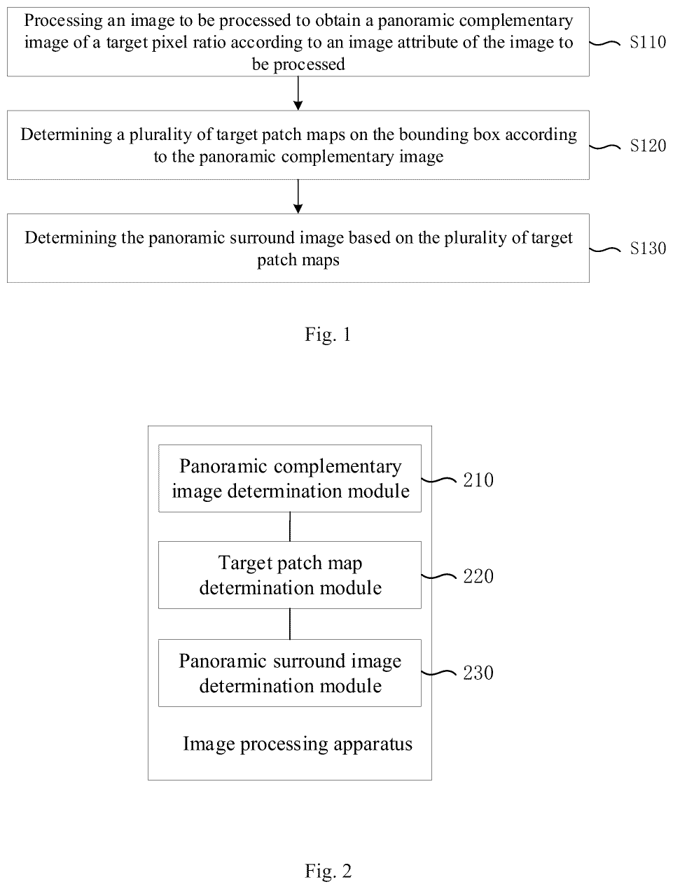

FIG. 1 is a flowchart of an image processing method provided by the embodiments of the present disclosure. The embodiments of the present disclosure are applicable to a situation in which an image for replacing the background of a video image is generated in a convenient manner. The method can be executed by an image processing apparatus, which can be implemented in the form of at least one of software and hardware, and optionally, through an electronic device, which may be a mobile terminal, a personal computer (PC) terminal, or a server, etc.

As shown in FIG. 1, the method includes:

S110. processing an image to be processed to obtain a panoramic complementary image of a target pixel ratio according to an image attribute of the image to be processed.

The apparatus for executing the image processing method provided by the embodiments of the present disclosure can be integrated into an application software that supports the processing function of an effect video, and the software can be installed in the electronic device. Optionally, the electronic device may be a mobile terminal or a PC terminal, etc. The application software can be a type of software for image/video processing, which will not be repeated here, as long as the image/video processing can be achieved. The application software can also be a specially developed application program to achieve the function of adding an effect and displaying an effect. The application software can also be integrated into a corresponding page, and users can achieve the processing on the effect video through the integrated page in the PC terminal.

In this embodiment, the image to be processed can be an image obtained by the application software in response to the user's effect triggering operation, that is, the image to be processed may be an image actively uploaded by the user, for example, a panoramic image displaying a scenic image. Optionally, an image upload frame can be developed in advance within the application software, such as a circular icon with a plus sign. When it is detected that the user has triggered the image upload frame, the application can retrieve the image library to take the selected image triggered in the image library as the image to be processed; alternatively, when the triggering image upload frame is detected, the camera device is called, and is used to capture and upload an image, to take the captured image as the image to be processed.

It should be noted that the technical solution of this embodiment can be executed during the real-time capturing process based on the mobile terminal, or can be executed after the system receives the image to be processed actively uploaded by the user. For example, when a user captures a video in real time based on the camera device on the terminal device, the application software detects that the user has triggered the image upload frame, and can respond to this operation to obtain the user's current captured video, and then parse and process the video, and the parsed video frame corresponding to the current time is used as the image to be processed. Alternatively, when the user actively uploads video data through the application software and triggers the image upload frame, the application will also respond to this operation, and then determine a specific frame from the video as the image to be processed according to the above method.

For example, when a user uses the camera device of a mobile terminal to capture a video in real time and triggers the image upload frame displayed on the display interface, the application software can automatically open the “album” in the mobile terminal according to the user's triggering operation on the image upload frame, and display the images in the “album” on the display interface. When the user's triggering operation on one image is detected, it indicates that the user wants to take the image as the background of the effect video. For example, the image selected by the user will be uploaded to the application software, so that the application software will take the image as the image to be processed. Alternatively, when a user uses the camera device of a mobile terminal to capture a video in real time and triggers the image upload frame displayed on the display interface, the application software can directly obtain the video frame at the current time from the video captured in real time by the camera device and take the video frame as the image to be processed. Of course, in practical application process, when the image to be processed is a panoramic image, the application can obtain a plurality of video frames in response to the triggering operation of the image upload frame, and concatenate the images of the plurality of video frames to take the final obtained image as the image to be processed, which will not be repeated in the embodiments of the present disclosure.

In this embodiment, when the application receives the image to be processed, it can process the image to be processed and obtain a panoramic complementary image of a target pixel ratio according to the image attribute of the image to be processed. The image attribute may be the information used to describe the image size, resolution, length-width ratio, and various information used to determine the current pixel ratio of the image to be processed. Of course, in practical applications, the image attribute may also be the current pixel ratio that has been determined through other software or programs, which is not limited by the embodiments of the present disclosure.

In this embodiment, when the image attribute of the image to be processed includes the current pixel ratio of the image to be processed, optionally, determining the current pixel ratio of the image to be processed, and determining the target processing method of the image to be processed according to the current pixel ratio and a preset pixel ratio; completing or cropping the image to be processed based on the target processing method, and determining the panoramic complementary image corresponding to the image to be processed.

The current pixel ratio of the image to be processed can be represented by the length-width ratio of the image. For example, when the length of the image to be processed is 6 units of length and the width is 1 unit of length, its length-width ratio is 6:1, and correspondingly, its current pixel ratio is also 6:1. In this embodiment, when the application software obtains the image to be processed, the current pixel ratio of the image to be processed can be automatically determined by running an image attribute determination program. Of course, in practical applications, when the image to be processed carries information that characterizes its length-width ratio, the application software can also directly retrieve this information, and take this attribute information as the current pixel ratio of the image to be processed.

In this embodiment, the preset pixel ratio is the preset image length-width ratio information preset based on the application software. It can be understood that the preset pixel ratio is the judgment basis for the application software to choose which method to process the image to be processed. For example, the preset pixel ratio can be set to 4:1. Of course, in the actual application process, this parameter can be adjusted according to the actual needs of effect video processing, which is not limited by the embodiments of the present disclosure.

In this embodiment, when the application software obtains the image to be processed and determines the current pixel ratio and preset pixel ratio of the image to be processed, the target processing method can be determined, and a complementary processing is performed on the image to be processed based on the target processing method, thereby obtaining the panoramic complementary image corresponding to the image to be processed. It can be understood that when the current pixel ratio of the image to be processed is inconsistent with the preset pixel ratio, the corresponding complementary method may also be different. For example, when the current pixel ratio of the image to be processed is inconsistent with the preset pixel ratio, the complementary image is the image obtained by filling the content of the image to be processed and adjusting the length-width ratio of the image to be processed. For example, when the current pixel ratio of the image to be processed is greater than the preset pixel ratio, the application software can complete the top and bottom sides of the image to be processed. When the current pixel ratio of the image to be processed is less than the preset pixel ratio, the application software can complete the left and right sides of the image to be processed. It can be understood that the pixel ratio information of the panoramic complementary image is consistent with the preset pixel ratio. The following will explain the complementary process of the image to be processed.

In this embodiment, when the current pixel ratio of the image to be processed is greater than the preset pixel ratio, cropping processing can also be performed on the image to be processed. For example, when the current pixel ratio of the image to be processed is 8:1 and the preset pixel ratio is 4:1, the application can directly crop the left and right sides of the image to be processed respectively, that is, the left side of the image to be processed is cropped by two units of length along the long edge, and at the same time the right side of the image to be processed is cropped by two units of length along the long edge. It can be understood that the panoramic complementary image obtained through cropping processing can also meet the requirements of the preset pixel ratio.

In this embodiment, in response to the current pixel ratio being greater than the preset pixel ratio, the target processing method is determined to be the edge complementary method. The edge complementary method includes a single edge complementary method or a double edge complementary method. When the application chooses the single edge complementary method, optionally, obtaining a pixel value of at least one pixel in the long edge top region of the image to be processed, and determining a top region pixel average value according to the pixel value; alternatively, obtaining a pixel value of at least one pixel in the long edge bottom region of the image to be processed, and determining a bottom region pixel average value according to the pixel value; based on the top region pixel average value or the bottom region pixel average value, processing the image to be processed to obtain the panoramic complementary image of the target pixel ratio.

In this embodiment, when the pixel ratio of the image to be processed is greater than the preset pixel ratio, it indicates that the ratio of the long edge to the wide edge of the image to be processed is too large. It can be understood that when the long edge of the image to be processed corresponds to the upper and lower sides of the image, and the application chooses the single edge complementary method to process the image to be processed, complementary processing is required for the top or bottom of the image to be processed.

Taking the process of completing the top of the image to be processed as an example, the application needs to determine pixel values of at least one row of pixels at the top of the image to be processed. For example, RGB values of the top row of pixels in the image to be processed are read, or RGB values of a total of three rows of pixels from the first to third row of pixels at the top of the image to be processed are read. For example, the average RGB value of these pixels is calculated according to a pre-written average value function. It can be understood that this calculation result is the top region pixel average value corresponding to the image to be processed. By adding multiple rows of pixels above the top of the image to be processed, and assigning color information to these pixels according to the top region pixel average value, the complementary processing of the top region of the image to be processed can be achieved. It can be understood that in the above process, there is no need to perform any operation on the bottom region of the image to be processed. Correspondingly, when choosing to perform the complementary processing on the bottom region of the image to be processed, there is no need to perform any operation on the top region of the image to be processed, which will not be repeated in the embodiments of the present disclosure.

In this embodiment, when the long edge of the image to be processed corresponds to the upper and lower sides of the image, and the application selects the double edge complementary method to process the image to be processed, optionally, the image to be processed is processed to obtain the panoramic complementary image of the target pixel ratio based on the top region pixel average value and the bottom region pixel average value.

For example, the application software needs to determine a plurality of rows of pixels in the image to be processed and select the pixels in the top row. For example, the RGB values of the plurality of pixels in this row are read and the average RGB value of pixels in this row is calculated according to a pre-written average value function. It can be understood that this calculation result is the pixel average value of the top pixels of the image to be processed. Similarly, the process of determining the average RGB value of the pixels in the bottom row in the image to be processed is similar to the above process, which will not be repeated in the embodiments of the present disclosure. When the application determines the average RGB value of the pixels in the top row and the average RGB value of the pixels in the bottom row, it is necessary to respectively determine a region at the top and the bottom of the image to be processed, that is, a region connected to the top of the image to be processed, and a region connected to the bottom of the image to be processed. For example, the color of the region connected to the top is filled according to the average RGB value of the pixels in the top row, while the color of the region connected to the bottom is filled according to the average RGB value of the pixels in the bottom row, so as to obtain a panoramic complementary image that meets the preset pixel ratio.

In this embodiment, when the pixel ratio of the image to be processed is greater than the preset pixel ratio, the initially obtained panoramic complementary image has poor display effect after only connecting one region at the top and the bottom of the image to be processed respectively and filing the color of the region according to the two average RGB values, that is, the connection between the image to be processed and the newly added regions at the upper and lower boundaries is too abrupt. Therefore, in order to optimize the display effect of the obtained panoramic complementary image, a transition region of a specific width can also be determined respectively in the top region and the bottom region of the original image to be processed.

Optionally, based on a preset transition ratio and the width information of a wide edge of the image to be processed, at least one of a first transition width and a second transition width is determined; based on the pixel average value of at least one row of pixels in the first transition width and the top region pixel average value, the top transition pixel values of the at least one row of pixels in the first transition width are determined; based on the pixel average value of at least one row of pixels in the second transition width and the bottom region pixel average value, the bottom transition pixel values of the at least one row of pixels in the second transition width are determined; the panoramic complementary image is determined based on at least one of the top transition pixel values, the bottom transition pixel values, the top region pixel average value, and the bottom region pixel average value.

The application software can determine the corresponding transition width according to the preset transition ratio and the width information of the wide edge of the image to be processed. The transition width is set to divide a certain region within the image to be processed. For example, when the preset transition ratio is 1/8 and the width of the wide edge of the image to be processed is 8 units of length, the application software can determine the first transition width of 1 unit of length in the top region of the image to be processed according to the above information, and determine the second transition width of 1 unit of length in the bottom region of the image to be processed according to the above information at the same time. It can be understood that in the actual application process, when the preset transition ratios for the top and the bottom of the image to be processed are different, the values of the transition widths finally determined by the application at the top and the bottom of the image are also different, and the preset transition ratio can be adjusted according to actual needs, and the embodiments of the present disclosure are not limited in this aspect.

In this embodiment, the first transition width and the second transition width include at least one row of pixels. Based on this, when the application determines a region of a total of two units of length in the top region and the bottom region of the image to be processed respectively, it can read the pixel values of each row of pixels in the top I unit of length and the pixel values of each row of pixels in the bottom 1 unit of length. For example, by substituting the pixel values of each row of pixels at the top and the top pixel average value into the pre-written average value calculation function, a plurality of pixel average values corresponding to each row of pixels within I unit of length of the top region can be obtained. Similarly, by substituting the pixel values of each row of pixels within I unit of length of the bottom and the bottom pixel average value into the pre-written average value calculation function, a plurality of pixel average values corresponding to each row of pixels within I unit of length of the bottom region can be obtained respectively. It can be understood that the calculated pixel average values respectively corresponding to each row of pixels are the transition pixel values of the image to be processed.

Updating the color attribute information of the corresponding pixels according to the transition pixel values of each row of pixels, and assigning color attribute information to the corresponding pixels according to the top pixel average value and the bottom pixel average value, the panoramic complementary image corresponding to the image to be processed can be obtained. At the same time, dividing the transition region at the top of the image to be processed and adding a complementary region, and dividing the transition region at the bottom of the image to be processed and adding a complementary region, the obtained complementary image can be made to meet the target pixel ratio. In actual application processes, the target pixel ratio can be 2:1. Of course, in actual application processes, the target pixel ratio can be adjusted according to the actual image processing needs, which is not limited by the embodiments of the present disclosure.

For example, when the pixel ratio information of the image to be processed is 8:1 and the preset pixel ratio is 4:1, the application software needs to add a plurality of rows of pixels at the top and the bottom of the image to be processed. It should be noted that during the process of adding the plurality of rows of pixels, the number of rows of pixels added at the top can be consistent with the number of rows of pixels added at the bottom. After adding the plurality of rows of pixels, the application can assign color attribute information to the plurality of rows of pixels added at the top according to the top pixel average value (RGB values of the pixels in the top row), and assign color attribute information to the plurality of rows of pixels added at the bottom according to the bottom pixel average value (RGB values of the pixels in the bottom row). For example, according to the preset transition ratio and the width information of the wide edge of the image to be processed, two transition regions can be divided in the top region and the bottom region of the image to be processed. After calculating the pixel average value of at least one row of pixels in the transition region, the original color attribute information of pixels in the two regions can be updated based on the pixel average value, thereby obtaining a panoramic complementary image with a pixel ratio of 4:1 corresponding to the image to be processed.

Of course, in actual application processes, a transition region can also be divided only in the top region of the image to be processed. For example, when the application determines the first transition width, at least one row of pixels can be determined in the top region of the image to be processed directly according to the first transition width. For example, the RGB values of these pixels can be read based on the method in the above description, and then a calculation is performed based on these RGB values to obtain a top region pixel average value. By updating the determined RGB values of the at least one row of pixels based on the top region pixel average value, a panoramic complementary image corresponding to the image to be processed can be obtained.

In this embodiment, a transition region can also be divided only in the bottom region of the image to be processed. For example, when the application determines the second transition width, at least one row of pixels can be determined in the bottom region of the image to be processed directly according to the second transition width. For example, the RGB values of these pixels are read based on the method in the above description, and then a calculation is performed based on these RGB values to obtain the bottom region pixel average value. By updating the determined RGB values of the at least one row of pixels based on the bottom region pixel average value, a panoramic complementary image corresponding to the image to be processed can be obtained.

From the above explanation, it can be determined that in the actual application processes, the application can choose to divide one region only at the top of the image to be processed as the transition region, or divide one region only at the bottom of the image to be processed as the transition region, and can also divide corresponding regions at both the top and the bottom of the image to be processed as the transition regions. The processing method can be selected according to actual needs, and the embodiments of the present disclosure are not limit in this aspect.

In this embodiment, when the current pixel ratio of the image to be processed is greater than the preset pixel ratio, the advantage of adding a plurality of rows of pixels at the top and the bottom of the image to be processed and dividing the transition region on the image to be processed according to the preset transition ratio is that, not only the obtained panoramic complementary image satisfies the target pixel ratio, which is easy for the application to perform subsequent processing of the image, but also the display effect of the image is optimized, making the content of the final rendered image more natural.

In this embodiment, there may also be a situation where the current pixel ratio of the image to be processed is smaller than the preset pixel ratio. In response to the current pixel ratio being smaller than the preset pixel ratio, the target processing method is determined to be a mirror complementary method. When the application chooses this method to complete the image to be processed, optionally, mirroring the image to be processed based on the mirror complementary method to obtain a panoramic complementary image that meets the target pixel ratio.

Those skilled in the art should understand that the mirroring processing of image can be divided into three types: horizontal mirroring, vertical mirroring, and diagonal mirroring. In this embodiment, since the current pixel ratio of the image to be processed is smaller than the preset pixel ratio, it is necessary to perform horizontal mirroring on the image to be processed. That is, the image of the image to be processed is mirrored and swapped using the left edge axis or the right edge axis of the image as a center to obtain a plurality of images to be processed that are horizontally arranged. It can be understood that for any two adjacent images, the images will present a visual effect of mirror swapping. For example, when the image obtained by concatenating a plurality of mirrored images meets the target pixel ratio, the concatenated image is the panoramic complementary image corresponding to the image to be processed.

It should be noted that when the current pixel ratio is equal to the target pixel ratio, the image to be processed is taken as a panoramic complementary image. That is, when the image to be processed has not been processed and its ratio of the long edge to the wide edge is equal to the target pixel ratio, the application does not need to perform complementary processing on the image to be processed, and directly take the image to be processed as the panoramic complementary image used in the subsequent process, which will not be repeated in the embodiments of the present disclosure.

S120. determining a plurality of target patch maps on the bounding box according to the panoramic complementary image.

In this embodiment, after the application determines the panoramic complementary image corresponding to the image to be processed, a plurality of target patch maps on the bounding box can be determined according to the image. The bounding box can be a model constructed by the application in a virtual three-dimensional space, and composed of a plurality of patch maps, such as a rectangular bounding box model or a cube bounding box model composed of six patch maps. Of course, it can also be a polyhedral bounding box model composed of a plurality of patch maps. Those skilled in the art should understand that with one bounding box model, at least one 3 dimension (3D) surrounding scene can be rendered. The following will illustrate the rectangular bounding box model as an example.

Those skilled in the art should understand that, a patch refers to a mesh in an application software that supports image rendering processing, which can be understood as an object used to carry an image in the application software. Each patch is composed of two triangles and contains multiple vertices. Correspondingly, according to the information of these vertices, the patch to which these vertices belong can also be determined. Based on this, it can be understood that in this embodiment, the six patches of the rectangular bounding box carry partial images on the panoramic complementary image respectively. Then, when the virtual camera is located at the center of the rectangular box, the images on the multiple patches are rendered from different perspectives to the display interface.

For example, when the image to be processed is an image of a scenic region, and the application software has determined the corresponding panoramic complementary image for the image to be processed, six different regions can be divided on the panoramic complementary image, and a three-dimensional spatial coordinate system and a rectangular bounding box model composed of six blank patch maps can be constructed in virtual space. For example, the contents of the six parts of the complementary image are sequentially mapped to the six patches of the rectangular bounding box model to obtain a plurality of target patch maps, thus achieving the construction of a 3D surrounding scene.

In the process of determining the target patch map, optionally, determining a patch map to be filled on the rectangular bounding box; determining target pixel values of a plurality of pixels on the patch map to be filled based on the panoramic complementary image; assigning a plurality of target pixel values to corresponding pixels on the corresponding patch map to be filled, and determining the target patch map.

For example, after the application constructs a three-dimensional spatial coordinate system in a virtual space, a rectangular bounding box model can be constructed. The center point of the rectangular bounding box model is the origin point of the three-dimensional spatial coordinate system. At the same time, the model is composed of at least six patch maps to be filled. Each patch map to be filled can be set to carry and represent a specific part of image of the panoramic complementary image. After constructing the rectangular bounding box model, the application can also add corresponding identifications to the plurality of patch maps to distinguish the patch maps to be filled on the rectangular bounding box model. For example, when there are 6 patch maps to be filled on the rectangular bounding box model, the plurality of patch maps respectively carry identifications such as number one, number two . . . number six and so on.

In this embodiment, when the application determines the plurality of patch maps to be filled on the rectangular bounding box model, target pixel values of the plurality of pixels on each patch map can be determined according to the panoramic complementary image. Optionally, the application can normalize the panoramic complementary image to obtain a target panoramic complementary image; determine a correspondence relationship between the pixel in the target panoramic complementary image and the corresponding longitude and latitude in the target sphere; determine the target longitudes and latitudes corresponding to the plurality of pixels on each patch map to be filled; and determine the target pixel values of the plurality of pixels according to the target longitudes and latitudes and the correspondence relationship.

It can be understood that when the panoramic complementary image determined by the application is in an equirectangular projection (ERP) format, the above process of determining the pixel values of the plurality of pixels on the patch map to be filled according to the panoramic complementary image is the process of establishing a mapping relationship between the plurality of pixels on the ERP image and the plurality of pixels on the patch map to be filled in the rectangular bounding box.

For example, when the application determines the panoramic complementary image, the panoramic complementary image can be stored in a UV texture space. Those skilled in the art should understand that when UVs are taken as two-dimensional texture coordinate points residing on the vertices of the polygon mesh, a two-dimensional texture coordinate system is defined, which is the UV texture space. In this space, U and V are used to define the coordinate axis, which is used to determine how to place a texture image on the surface of a three-dimensional model. That is, UVs provide a connection relationship between the model surface and the texture image, and are responsible for determining which vertex on the model surface a pixel on the texture image should be placed on, thereby covering the entire texture on the model. In this embodiment, based on the UV texture space, the UV values of the plurality of pixels in the panoramic complementary image can be determined.

In this embodiment, when the application determines the UV values of the plurality of pixels in the target panoramic complementary image, it cannot directly map the target panoramic complementary image to the plurality of patch maps to be filled of the rectangular bounding box model. Therefore, it is also necessary to introduce a target sphere in the virtual three-dimensional coordinate system, that is, first map the plurality of pixels of the target panoramic complementary image to the longitude and latitude (φ, θ) of the target sphere, and then map the longitude and latitude (φ, θ) of the target sphere to the plurality of patch maps to be filled of the rectangular bounding box model. The center point of the rectangular bounding box coincides with the center point of the target sphere, and the rectangular bounding box is located inside the target sphere.

In the process of determining the correspondence relationship between the plurality of pixels in the target panoramic complementary image and the plurality of longitudes and latitudes in the target sphere, optionally, determining a texture coordinate to be processed of the current pixel for each pixel on the patch map to be filled, normalizing the texture coordinate to be processed based on the edge length information of the rectangular bounding box to obtain the target texture coordinate; and determining the target longitudes and latitudes of the plurality of target texture coordinates according to the plurality of target texture coordinates and the initial longitude or latitude of the current patch map to be filled to which the current pixel to be processed belongs.

It can be understood that when the application determines the UV values of the plurality of pixels in the target panoramic complementary image, these values can be used to obtain the texture coordinates to be processed of the plurality of pixels on the patch map to be filled through a one-to-one mapping relationship. At the same time, since the texture coordinates to be processed of the plurality of pixels are all within the range of [0,1], it is also necessary to perform a normalizing process on the target panoramic complementary image. That is, in the case where the edge length information of the rectangular bounding box is determined, the values of two times the values of the texture coordinates to be processed of the plurality of pixels and then subtracted by one are taken, and the texture coordinate values to be processed of the plurality of pixels are updated based on these values, so that the texture coordinates of the plurality of pixels are all within the range of [−1,1]. It can be understood that the updated texture coordinates of the plurality of pixels are the target texture coordinates.

While determining the target texture coordinates, the application also needs to determine the initial longitude or latitude values corresponding to the plurality of patch maps to be filled on the target sphere. For example, for the patch maps to be filled on a rectangular bounding box model, a ray can be established from the origin of the virtual three-dimensional coordinate system towards one of the four patch maps to be filled perpendicular to the horizontal plane. It can be understood that an intersection point is generated between the ray and the target sphere, and after determining the longitude and latitude of the intersection point on the target sphere, the point that has a mapping relationship with the intersection point can be determined on the rectangular bounding box, the following is an explanation of the process of determining the latitude and longitude of the intersection point.

In this embodiment, after obtaining the intersection point on the target sphere, the application can generate a projection of the ray corresponding to the intersection point in the XOY plane of the virtual three-dimensional coordinate system, and determine an initial straight line as a baseline in the XOY plane. Based on this, the angle between the ray projection and the baseline can be determined. For example, the application can calculate the ratio of this angle to 2π, which can be substituted into a preset trigonometric function to obtain the point corresponding to the intersection point on the target sphere and located on the rectangular bounding box.

It can be understood that when starting from the origin of the virtual three-dimensional coordinate system and establishing a ray towards one of the two patch maps to be filled parallel to the horizontal plane, the ray can generate an intersection point with the patch map to be filled. In this case, the application can generate a projection of the ray corresponding to the intersection point in the XOZ plane of the virtual three-dimensional coordinate system, and determine an initial straight line as a baseline in the XOZ plane. Based on this, the angle between the ray projection and the baseline can be determined, and then the point corresponding to the intersection point on the target sphere and located on the rectangular bounding box can be determined according to the above method.

It should be noted that in the process of determining the mapping relationship between the points on the target sphere and the points on the patch maps to be filled in the rectangular bounding box, after the angle between the ray and the corresponding baseline is determined, multiple trigonometric functions can be used for calculation and solution, which is not limited by the embodiments of the present disclosure.

In this embodiment, when the application determines the target longitude and latitude values of corresponding points on the target sphere according to the normalized texture coordinates on the target panoramic complementary image, the pixels corresponding to the points on the target sphere can be determined on the patch map to be filled, thereby establishing the mapping relationship between the target panoramic complementary image and the patch map to be filled. According to this mapping relationship and the longitudes and latitudes of a plurality of points on the target sphere, the pixel values of the plurality of pixels on the patch map to be filled can be obtained, these pixel values are the target pixel values.

S130. determining the panoramic surround image based on the plurality of target patch maps.

In this embodiment, when the application determines the target pixel values of pixels of the plurality of patch maps to be filled of the rectangular bounding box, the panoramic surround image can be constructed. It can be understood that the application can write the target pixel values of the plurality of pixels into the rendering engine, so that the rendering engine can render the corresponding image in the display interface. The rendering engine is the program that controls the graphics processing unit (GPU) to render relevant images, that is, the rendering engine can enable the computer to complete the task of drawing the panoramic surround image, which will not be repeated in the embodiments of the present disclosure.

In this embodiment, after the application determines the panoramic surround image, virtual display can also be performed based on the panoramic surround image. For example, when the image to be processed is a panoramic image of an outdoor scenic region and the application has determined the panoramic surround image corresponding to this image, the panoramic surround image can be marked. For example, the panoramic surround image can be assigned the identification of “outdoor scene”. For example, the panoramic surround image is associated with a specific control within the application. Based on this, when a user triggering the control is detected, the panoramic surround image associated with the control can be called and the image can be rendered to the display interface. Those skilled in the art should understand that in the case of limited display interface size, the content of the panoramic surround image cannot be fully displayed. Only when the user changing the viewing angle through a touch operation is detected, the application will render other parts of the panoramic surround image to the display interface according to the user's operation. The embodiments of the present disclosure will not repeat it here.

It should be noted that for the panoramic surround image generated in real-time according to the embodiments of the present disclosure, the application can also store it as a panoramic surround image to be selected, and then call the image at any time in the subsequent process. The embodiments of the present disclosure are not limited in this aspect.

In the technical solution of the embodiments of the present disclosure, the panoramic complementary image corresponding to the image to be processed is determined firstly, and then a plurality of target patch maps on the rectangular bounding box are determined according to the panoramic complementary image. For example, determining the panoramic surround image based on the plurality of target patch maps not only generates the panoramic surround image corresponding to the image to be processed based on the mobile terminal, but also improves the image processing efficiency in a concise way, and improves the user experience while meeting the user's personalized needs.

FIG. 2 is a structural diagram of an image processing apparatus provided by the embodiments of the present disclosure. As shown in FIG. 2, the apparatus includes a panoramic complementary image determination module 210, a target patch map determination module 220, and a panoramic surround image determination module 230.

The panoramic complementary image determination module 210 is configured to process an image to be processed to obtain a panoramic complementary image of a target pixel ratio according to an image attribute of the image to be processed.

The target patch map determination module 220 is configured to determine a plurality of target patch maps on a bounding box according to the panoramic complementary image; in which a displayed content on the bounding box corresponds to the panoramic complementary image.

The panoramic surround image determination module 230 is configured to determine a panoramic surround image based on the plurality of target patch maps.

On the basis of the above technical solution, the image attribute includes a current pixel ratio of the image to be processed, and the panoramic complementary image determination module 210 includes a target processing method determination unit and a panoramic complementary image determination unit.

The target processing method determination unit is configured to determine a current pixel ratio of the image to be processed, and determine a target processing method for the image to be processed according to the current pixel ratio and a preset pixel ratio.

The panoramic complementary image determination unit is configured to complete or crop the image to be processed based on the target processing method, and obtain the panoramic complementary image corresponding to the image to be processed.

Optionally, the target processing method determination unit is further configured to determine the target processing method to be an edge complementary method in response to the current pixel ratio being greater than the preset pixel ratio; in which the edge complementary method includes a single edge complementary method or a double edge complementary method; and determine the target processing method to be a mirror complementary method in response to the current pixel ratio being smaller than the preset pixel ratio.

Optionally, on the basis of the above technical solution, the target processing method is the edge complementary method.

The panoramic complementary image determination unit is further configured to obtain a pixel value of at least one pixel in a long edge top region of the image to be processed, and determine a top region pixel average value according to the pixel value; or obtain a pixel value of at least one pixel in a long edge bottom region of the image to be processed, and determine a bottom region pixel average value according to the pixel value; and based on the top region pixel average value or the bottom region pixel average value, process the image to be processed to obtain the panoramic complementary image of the target pixel ratio.

Optionally, based on the above technical solutions, the target processing method is the double edge complementary method.

The panoramic complementary image determination unit is further configured to obtain a pixel value of at least one pixel in a long edge top region of the image to be processed, and determine a top region pixel average value according to the pixel value; obtain a pixel value of at least one pixel in a long edge bottom region of the image to be processed, and determine a bottom region pixel average value according to the pixel value; and based on the top region pixel average value and the bottom region pixel average value, process the image to be processed to obtain the panoramic complementary image of the target pixel ratio.

On the basis of the above technical solution, the image processing apparatus further includes a transition pixel value determination module.

The transition pixel value determination module is configured to determine at least one of a first transition width and a second transition width based on a preset transition ratio and width information of a wide edge of the image to be processed; in which at least one of the first transition width and the second transition width includes at least one row of pixels; determine top transition pixel values of at least one row of pixels in the first transition width based on a pixel average value of the at least one row of pixels in the first transition width and the top region pixel average value; determine bottom transition pixel values of at least one row of pixels in the second transition width based on a pixel average value of the at least one row of pixels in the second transition width and the bottom region pixel average value; and determine the panoramic complementary image based on at least one of the top transition pixel values, bottom transition pixel values, the top region pixel average value, and the bottom region pixel average value.

Optionally, on the basis of the above technical solution, the target processing method is the mirror complementary method.

The panoramic complementary image determination unit is further configured to mirror the image to be processed based on the mirror complementary method to obtain a panoramic complementary image that meets the target pixel ratio.

On the basis of the above technical solution, the target patch map determination module 220 includes a to-be-filled patch map determination unit, a target pixel value determination unit, and a target patch map determination unit.

The to-be-filled patch map determination unit is configured to determine patch maps to be filled on the bounding box.

The target pixel value determination unit is configured to determine target pixel values of a plurality of pixels on each patch map to be filled based on the panoramic complementary image.

The target patch map determination unit is configured to assign the target pixel values of the plurality of pixels to corresponding pixels on corresponding patch maps to be filled, and determine the plurality of target patch maps.

Optionally, the target pixel value determination unit is further configured to normalize the panoramic complementary image to obtain a target panoramic complementary image; determine a correspondence relationship between a pixel in the target panoramic complementary image and corresponding longitude and latitude in a target sphere; in which a center point of the bounding box coincides with a center point of the target sphere, and the bounding box is located inside the target sphere; determine target longitudes and latitudes corresponding to the plurality of pixels on each patch map to be filled; and determine the target pixel values of the plurality of pixels based on the target longitudes and latitudes and the correspondence relationship.

Optionally, the target pixel value determination unit is further configured to determine texture coordinates to be processed of at least one pixel on the patch map to be filled, and normalize the texture coordinates to be processed based on edge length information of the bounding box to obtain target texture coordinates; and determine the target longitude and latitude of the target texture coordinates according to the target texture coordinates and initial longitude or latitude values of a current patch map to be filled to which a current pixel to be processed belong.

On the basis of the above technical solution, the image processing apparatus further includes a virtual display module.

The virtual display module is configured to perform virtual display based on the panoramic surround image.

The technical solution provided in this embodiment first determines the panoramic complementary image corresponding to the image to be processed, and then determines a plurality of target patch maps on the rectangular bounding box according to the panoramic complementary image. For example, determining the panoramic surround image based on the plurality of target patch maps can not only generate the panoramic surround image corresponding to the image to be processed based on the mobile terminal, but also improve image processing efficiency in a concise way, and improve the user experience while meeting the personalized needs of users.

The image processing apparatus provided by the embodiments of the present disclosure can execute the image processing method provided by any embodiment of the present disclosure, and has corresponding functional modules and effects for executing the method.

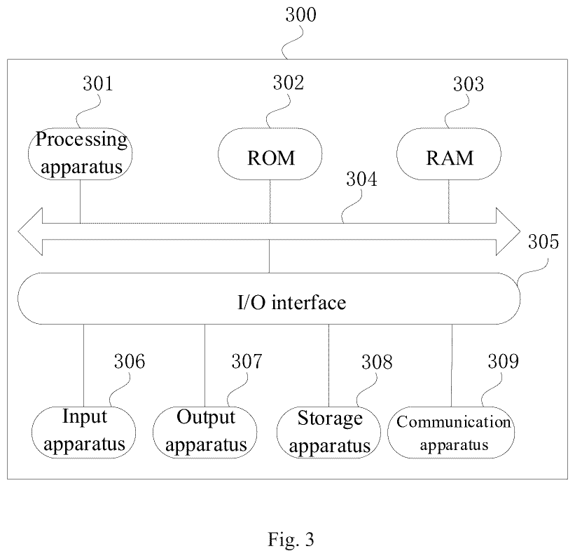

FIG. 3 is a structural diagram of an electronic device provided by the embodiments of the present disclosure. Referring to FIG. 3 below, FIG. 3 is a structural diagram of the electronic device (such as the terminal device or server in FIG. 3) 300 suitable for implementing the embodiments of the present disclosure. The terminal device in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), or the like, and fixed terminals such as a digital TV, a desktop computer, or the like. The electronic device illustrated in FIG. 3 is merely an example, and should not pose any limitation to the functions and the range of use of the embodiments of the present disclosure.

As shown in FIG. 3, the electronic device 300 may include a processing apparatus 301 (e.g., a central processing unit, a graphics processing unit, etc.), which can perform various suitable actions and processing according to a program stored in a read-only memory (ROM) 302 or a program loaded from a storage apparatus 308 into a random-access memory (RAM) 303. The RAM 303 further stores various programs and data required for operations of the electronic device 300. The processing apparatus 301, the ROM 302, and the RAM 303 are interconnected by means of a bus 304. An input/output (I/O) interface 305 is also connected to the bus 304.

Usually, the following apparatus may be connected to the I/O interface 305; an input apparatus 306 including, for example, a touch screen, a touch pad, a keyboard, a mouse, a camera, a microphone, an accelerometer, a gyroscope, or the like; an output apparatus 307 including, for example, a liquid crystal display (LCD), a loudspeaker, a vibrator, or the like; a storage apparatus 308 including, for example, a magnetic tape, a hard disk, or the like; and a communication apparatus 309. The communication apparatus 309 may allow the electronic device 300 to be in wireless or wired communication with other devices to exchange data. While FIG. 3 illustrates the electronic device 300 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 309 and installed, or may be installed from the storage apparatus 308, or may be installed from the ROM 302. When the computer program is executed by the processing apparatus 301, the above-mentioned functions defined in the methods of some embodiments of the present disclosure are performed.

The image processing apparatus provided by the embodiments of the present disclosure has the same invention concept as the image processing method provided by the above embodiments, for the technical details not illustrated in detail in this embodiment, please refer to the above embodiments, and this embodiment has the same effect as the above embodiments.

The embodiments of the present disclosure further provide a computer-readable storage medium, a computer program is stored on the computer-readable storage medium, and when executed by a processing device, the computer program implements the image processing method provided by the above embodiments.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries at least one program, and when the at least one program is executed by the electronic device, the electronic device is caused to:
process an image to be processed to obtain a panoramic complementary image of a target pixel ratio according to an image attribute of the image to be processed;
determine a plurality of target patch maps on a bounding box according to the panoramic complementary image; in which a displayed content on the bounding box corresponds to the panoramic complementary image; and
determine a panoramic surround image based on the plurality of target patch maps.

The computer program codes for performing the operations of the present disclosure may be written in one or more programming languages or a combination thereof. The above-mentioned programming languages include but are not limited to object-oriented programming languages such as Java. Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances. For example, the first acquisition unit can also be described as “a unit that obtains at least two Internet protocol addresses”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to at least one embodiment of the present disclosure, [example one] provides an image processing method, the method includes:
processing an image to be processed to obtain a panoramic complementary image of a target pixel ratio according to an image attribute of the image to be processed;
determining a plurality of target patch maps on a bounding box according to the panoramic complementary image; in which a displayed content on the bounding box corresponds to the panoramic complementary image; and
determining a panoramic surround image based on the plurality of target patch maps.

According to at least one embodiment of the present disclosure, [example two] provides an image processing method, the method further includes the following.

Optionally, the image attribute includes a current pixel ratio of the image to be processed, the processing of the image attribute of the image to be processed to obtain the panoramic complementary image of the target pixel ratio includes:
determining a current pixel ratio of the image to be processed, and determining a target processing method for the image to be processed according to the current pixel ratio and a preset pixel ratio; and
completing or cropping the image to be processed based on the target processing method, and obtaining the panoramic complementary image corresponding to the image to be processed.

According to at least one embodiment of the present disclosure, [example three] provides an image processing method, the method further includes the following.

Optionally, the determining of the target processing method for the image to be processed according to the current pixel ratio and the preset pixel ratio includes:
determining the target processing method to be an edge complementary method in response to the current pixel ratio being greater than the preset pixel ratio; in which the edge complementary method includes a single edge complementary method or a double edge complementary method; and
determining the target processing method to be a mirror complementary method in response to the current pixel ratio being smaller than the preset pixel ratio.

According to at least one embodiment of the present disclosure, [example four] provides an image processing method, the method further includes the following.

Optionally, the target processing method is the single edge complementary method, and the completing of the image to be processed based on the target processing method and determining the panoramic complementary image corresponding to the image to be processed includes:
obtaining a pixel value of at least one pixel in a long edge top region of the image to be processed, and determining a top region pixel average value according to the pixel value; or obtaining a pixel value of at least one pixel in a long edge bottom region of the image to be processed, and determining a bottom region pixel average value according to the pixel value; and
based on the top region pixel average value or the bottom region pixel average value, processing the image to be processed to obtain the panoramic complementary image of the target pixel ratio.

According to at least one embodiment of the present disclosure, [example five] provides an image processing method, the method further includes the following.

Optionally, the target processing method is the double edge complementary method, and the completing of the image to be processed based on the target processing method and determining the panoramic complementary image corresponding to the image to be processed includes:
obtaining a pixel value of at least one pixel in a long edge top region of the image to be processed, and determining a top region pixel average value according to the pixel value; obtaining a pixel value of at least one pixel in a long edge bottom region of the image to be processed, and determining a bottom region pixel average value according to the pixel value; and
based on the top region pixel average value and the bottom region pixel average value, processing the image to be processed to obtain the panoramic complementary image of the target pixel ratio.

According to at least one embodiment of the present disclosure, [example six] provides an image processing method, the method further includes the following.

Optionally, determining at least one of a first transition width and a second transition width based

on a preset transition ratio and width information of a wide edge of the image to be processed; in which at least one of the first transition width and the second transition width comprises at least one row of pixels;
determining top transition pixel values of at least one row of pixels in the first transition width based on a pixel average value of the at least one row of pixels in the first transition width and the top region pixel average value; determining bottom transition pixel values of at least one row of pixels in the second transition width based on a pixel average value of the at least one row of pixels in the second transition width and the bottom region pixel average value; and
determining the panoramic complementary image based on at least one of the top transition pixel values, bottom transition pixel values, the top region pixel average value, and the bottom region pixel average value.

According to at least one embodiment of the present disclosure, [example seven] provides an image processing method, the method further includes the following.

Optionally, the target processing method is the mirror complementary method, and the completing of the image to be processed based on the target processing method and determining the panoramic complementary image corresponding to the image to be processed includes:
mirroring the image to be processed based on the mirror complementary method to obtain a panoramic complementary image that meets the target pixel ratio.

According to at least one embodiment of the present disclosure, [example eight] provides an image processing method, the method further includes the following.

Optionally, determining patch maps to be filled on the bounding box;
determining target pixel values of a plurality of pixels on each patch map to be filled based on the panoramic complementary image; and
assigning the target pixel values of the plurality of pixels to corresponding pixels on corresponding patch maps to be filled, and determining the plurality of target patch maps.

According to at least one embodiment of the present disclosure, [example nine] provides an image processing method, the method further includes the following.

Optionally, normalizing the panoramic complementary image to obtain a target panoramic complementary image;
determining a correspondence relationship between a pixel in the target panoramic complementary image and corresponding longitude and latitude in a target sphere; in which a center point of the bounding box coincides with a center point of the target sphere, and the bounding box is located inside the target sphere;
determining target longitudes and latitudes corresponding to the plurality of pixels on each patch map to be filled; and
determining the target pixel values of the plurality of pixels based on the target longitudes and latitudes and the correspondence relationship.

According to at least one embodiment of the present disclosure, [example ten] provides an image processing method, the method further includes the following.

Optionally, determining texture coordinates to be processed of at least one pixel on the patch map to be filled, and normalizing the texture coordinates to be processed based on edge length information of the bounding box to obtain target texture coordinates; and
determining the target longitude and latitude of the target texture coordinates according to the target texture coordinates and initial longitude or latitude values of a current patch map to be filled to which a current pixel to be processed belong.

According to at least one embodiment of the present disclosure, [example eleven] provides an image processing method, the method further includes the following.

Optionally, performing virtual display based on the panoramic surround image.

According to at least one embodiment of the present disclosure, [example three] provides an image processing apparatus, the apparatus further includes:
a panoramic complementary image determination module, configured to process an image to be processed to obtain a panoramic complementary image of a target pixel ratio according to an image attribute of the image to be processed;
a target patch map determination module, configured to determine a plurality of target patch maps on a bounding box according to the panoramic complementary image; in which a displayed content on the bounding box corresponds to the panoramic complementary image; and
a panoramic surround image determination module, configured to determine a panoramic surround image based on the plurality of target patch maps.

Furthermore, although multiple operations are illustrated in a specific order, this should not be understood as requiring the operations to be executed in the specific order shown or in sequential order. In certain environments, multitasking and parallel processing may be advantageous. Similarly, although multiple implementation details are included in the above discussion, the details should not be interpreted as limiting the scope of the present disclosure. The features described in the context of individual embodiment can also be combined to be implemented in a single embodiment. On the contrary, various features described in the context of a single embodiment can also be implemented separately or in any suitable sub combination in multiple embodiments.

1. An image processing method, comprising:
processing an image to be processed to obtain a panoramic complementary image of a target pixel ratio according to an image attribute of the image to be processed;
determining a plurality of target patch maps on a bounding box according to the panoramic complementary image; wherein a displayed content on the bounding box corresponds to the panoramic complementary image; and
determining a panoramic surround image based on the plurality of target patch maps.

2. The method according to claim 1, wherein the image attribute comprises a current pixel ratio of the image to be processed, the processing of the image attribute of the image to be processed to obtain the panoramic complementary image of the target pixel ratio comprises:
determining the current pixel ratio of the image to be processed, and determining a target processing method for the image to be processed according to the current pixel ratio and a preset pixel ratio; and
completing or cropping the image to be processed based on the target processing method, and obtaining the panoramic complementary image corresponding to the image to be processed.

3. The method according to claim 2, wherein the determining of the target processing method for the image to be processed according to the current pixel ratio and the preset pixel ratio comprises:
determining the target processing method to be an edge complementary method in response to the current pixel ratio being greater than the preset pixel ratio; wherein the edge complementary method comprises a single edge complementary method or a double edge complementary method; and
determining the target processing method to be a mirror complementary method in response to the current pixel ratio being smaller than the preset pixel ratio.

4. The method according to claim 3, wherein the target processing method is the single edge complementary method, and the completing of the image to be processed based on the target processing method and determining the panoramic complementary image corresponding to the image to be processed comprises:
obtaining a pixel value of at least one pixel in a long edge top region of the image to be processed, and determining a top region pixel average value according to the pixel value; or obtaining a pixel value of at least one pixel in a long edge bottom region of the image to be processed, and determining a bottom region pixel average value according to the pixel value; and
based on the top region pixel average value or the bottom region pixel average value, processing the image to be processed to obtain the panoramic complementary image of the target pixel ratio.

5. The method according to claim 3, wherein the target processing method is the double edge complementary method, and the completing of the image to be processed based on the target processing method and determining the panoramic complementary image corresponding to the image to be processed comprises:
obtaining a pixel value of at least one pixel in a long edge top region of the image to be processed, and determining a top region pixel average value according to the pixel value; obtaining a pixel value of at least one pixel in a long edge bottom region of the image to be processed, and determining a bottom region pixel average value according to the pixel value; and
based on the top region pixel average value and the bottom region pixel average value, processing the image to be processed to obtain the panoramic complementary image of the target pixel ratio.

6. The method according to claim 4, further comprising:
determining at least one of a first transition width and a second transition width based on a preset transition ratio and width information of a wide edge of the image to be processed; wherein at least one of the first transition width and the second transition width comprises at least one row of pixels;
determining top transition pixel values of at least one row of pixels in the first transition width based on a pixel average value of the at least one row of pixels in the first transition width and the top region pixel average value; determining bottom transition pixel values of at least one row of pixels in the second transition width based on a pixel average value of the at least one row of pixels in the second transition width and the bottom region pixel average value; and
determining the panoramic complementary image based on at least one of the top transition pixel values, bottom transition pixel values, the top region pixel average value, and the bottom region pixel average value.

7. The method according to claim 3, wherein the target processing method is the mirror complementary method, and the completing of the image to be processed based on the target processing method and determining the panoramic complementary image corresponding to the image to be processed comprises:
mirroring the image to be processed based on the mirror complementary method to obtain a panoramic complementary image that meets the target pixel ratio.

8. The method according to claim 1, wherein the determining of the plurality of target patch maps on the bounding box according to the panoramic complementary image comprises:
determining patch maps to be filled on the bounding box;
determining target pixel values of a plurality of pixels on each patch map to be filled based on the panoramic complementary image; and
assigning the target pixel values of the plurality of pixels to corresponding pixels on corresponding patch maps to be filled, and determining the plurality of target patch maps.

9. The method according to claim 8, wherein the determining of target pixel values of the plurality of pixels on each patch map to be filled based on the panoramic complementary image comprises:
normalizing the panoramic complementary image to obtain a target panoramic complementary image;
determining a correspondence relationship between a pixel in the target panoramic complementary image and corresponding longitude and latitude in a target sphere; wherein a center point of the bounding box coincides with a center point of the target sphere, and the bounding box is located inside the target sphere;
determining target longitudes and latitudes corresponding to the plurality of pixels on each patch map to be filled; and
determining the target pixel values of the plurality of pixels based on the target longitudes and latitudes and the correspondence relationship.

10. The method according to claim 9, wherein the determining of the target longitudes and latitudes corresponding to corresponding pixels on each patch map to be filled comprises:
determining texture coordinates to be processed of at least one pixel on the patch map to be filled, and normalizing the texture coordinates to be processed based on edge length information of the bounding box to obtain target texture coordinates; and
determining target longitude and latitude of the target texture coordinates according to the target texture coordinates and initial longitude or latitude values of a current patch map to be filled to which a current pixel to be processed belong.

11. The method according to claim 1, further comprising:
performing virtual display based on the panoramic surround image.

12. (canceled)

13. An electronic device, comprising:
at least one processor; and
a storage apparatus, configured to store at least one program,
the at least one program causes the at least one processor to:
process an image to be processed to obtain a panoramic complementary image of a target pixel ratio according to an image attribute of the image to be processed;
determine a plurality of target patch maps on a bounding box according to the panoramic complementary image; wherein a displayed content on the bounding box corresponds to the panoramic complementary image; and
determine a panoramic surround image based on the plurality of target patch maps.

14. A non-transitory readable storage medium, comprising a computer program, wherein the computer program is configured to execute the an image processing method when executed by a computer processor, the method comprises:
processing an image to be processed to obtain a panoramic complementary image of a target pixel ratio according to an image attribute of the image to be processed;
determining a plurality of target patch maps on a bounding box according to the panoramic complementary image; wherein a displayed content on the bounding box corresponds to the panoramic complementary image; and
determining a panoramic surround image based on the plurality of target patch maps.

15. The electronic device according to claim 13, wherein the at least one processor to is further caused to:
determine a current pixel ratio of the image to be processed, and determine a target processing method for the image to be processed according to the current pixel ratio and a preset pixel ratio; and
complete or crop the image to be processed based on the target processing method, and obtain the panoramic complementary image corresponding to the image to be processed.

16. The electronic device according to claim 15, wherein the at least one processor to is further caused to:
determine the target processing method to be an edge complementary method in response to the current pixel ratio being greater than the preset pixel ratio; wherein the edge complementary method comprises a single edge complementary method or a double edge complementary method;
and determine the target processing method to be a mirror complementary method in response to the current pixel ratio being smaller than the preset pixel ratio.

17. The electronic device according to claim 16, wherein the target processing method is the single edge complementary method, and the at least one processor to is further caused to:
obtain a pixel value of at least one pixel in a long edge top region of the image to be processed, and determine a top region pixel average value according to the pixel value; or obtain a pixel value of at least one pixel in a long edge bottom region of the image to be processed, and determine a bottom region pixel average value according to the pixel value; and
based on the top region pixel average value or the bottom region pixel average value, process the image to be processed to obtain the panoramic complementary image of the target pixel ratio.

18. The electronic device according to claim 16, wherein the target processing method is the double edge complementary method, and the at least one processor to is further caused to:
obtain a pixel value of at least one pixel in a long edge top region of the image to be processed, and determine a top region pixel average value according to the pixel value; obtain a pixel value of at least one pixel in a long edge bottom region of the image to be processed, and determine a bottom region pixel average value according to the pixel value; and
based on the top region pixel average value and the bottom region pixel average value, process the image to be processed to obtain the panoramic complementary image of the target pixel ratio.

19. The electronic device according to claim 17, wherein the at least one processor to is further caused to:
determine at least one of a first transition width and a second transition width based on a preset transition ratio and width information of a wide edge of the image to be processed; wherein at least one of the first transition width and the second transition width comprises at least one row of pixels;
determine top transition pixel values of at least one row of pixels in the first transition width based on a pixel average value of the at least one row of pixels in the first transition width and the top region pixel average value; determining bottom transition pixel values of at least one row of pixels in the second transition width based on a pixel average value of the at least one row of pixels in the second transition width and the bottom region pixel average value; and
determine the panoramic complementary image based on at least one of the top transition pixel values, bottom transition pixel values, the top region pixel average value, and the bottom region pixel average value.

20. The electronic device according to claim 16, wherein the target processing method is the mirror complementary method, and the at least one processor to is further caused to:
mirror the image to be processed based on the mirror complementary method to obtain a panoramic complementary image that meets the target pixel ratio.

21. The electronic device according to claim 13, wherein the at least one processor to is further caused to:
determine patch maps to be filled on the bounding box;
determine target pixel values of a plurality of pixels on each patch map to be filled based on the panoramic complementary image; and
assign the target pixel values of the plurality of pixels to corresponding pixels on corresponding patch maps to be filled, and determine the plurality of target patch maps.
